(19) United States
(12) Patent Application Publication
(10) Pub. No.: US 2024/0397031 A1
(43) Pub. Date: Nov. 28, 2024

(54) LIGHT FIELD DISPLAY APPARATUS

(71) Applicant: AUO Corporation, Hsinchu (TW)

(72) Inventors: Po-Jui Chen, Taipei (TW); Cheng-Ting Tsai, Taipei (TW); Chi-Jui Chang, Taipei (TW); Chung-Chih Wu, Taipei (TW); Guo-Dung Su, Taipei (TW); Ren-Wei Liao, Hsinchu (TW); Sheng-Wen Cheng, Hsinchu (TW); Jen-Lang Tung, Hsinchu (TW)

(73) Assignee: AUO Corporation, Hsinchu (TW)

(21) Appl. No.: 18/491,806

(22) Filed: Oct. 23, 2023

(30) Foreign Application Priority Data
May 25, 2023 (TW) 112119441

(51) Int. Cl. H04N 13/354; G02B 1/00; G02B 3/00; G02F 1/13; H04N 13/302; H04N 13/324

(52) U.S. Cl. CPC H04N 13/354; G02B 1/002; G02B 3/0068; G02F 1/1323; H04N 13/302; H04N 13/324

(57) ABSTRACT

A light field display apparatus includes a display element and a switching element. The display element has a plurality of pixels. The switching element is disposed on the display element. The switching element includes a polarizer, a liquid crystal layer, and a metalens array. The metalens array has a plurality of metalens units overlapping the plurality of pixels. The polarizer, the liquid crystal layer, and the metalens array are sequentially disposed on the plurality of pixels of the display element.

### CROSS-REFERENCE TO RELATED APPLICATION

This application claims the priority benefit of Taiwan application serial no. 112119441, filed on May 25, 2023. The entirety of the above-mentioned patent application is hereby incorporated by reference herein and made a part of this specification.

### BACKGROUND

### Technical Field

The disclosure relates to a display apparatus, and in particular, relates to a light field display apparatus.

### Description of Related Art

The principle of light field display technology is to simulate the visual imaging of human eyes. That is, in a specific field, all the light information in all directions reflected by an object is captured. Next, the light information including all directions is sent back, and finally the object imaging is truly reproduced. The light information includes not only the color and brightness of the light, but also the position, direction, and distance. In a space, each light ray includes three-dimensional position information and three-dimensional direction information. In a conventional flat panel display apparatus, the two-dimensional position information is retained, but the three-dimensional direction information is lost. The light field display apparatus retains complete light information. Therefore, the light field display apparatus can provide human eyes with the most realistic visual experience.

A light field display apparatus includes a display element having a plurality of pixels. The plurality of pixels of the display element can provide information of a plurality of views of the same point of the object, and these pixels can form a voxel. However, the more pixels contained in each voxel, the fewer pixels can be allocated to each view, resulting in a decrease in the spatial resolution of a single view.

### SUMMARY

The disclosure provides a light field display apparatus with high resolution.

The disclosure provides a light field display apparatus including a display element and a switching element. The display element has a plurality of pixels. The switching element is disposed on the display element. The switching element includes a polarizer, a liquid crystal layer, and a metalens array. The metalens array has a plurality of metalens units overlapping the plurality of pixels. The polarizer, the liquid crystal layer, and the metalens array are sequentially disposed on the plurality of pixels of the display element.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a cross-sectional schematic view of a light field display apparatus according to an embodiment of the disclosure.

FIG. 2 is a cross-sectional schematic view of the light field display apparatus according to an embodiment of the disclosure.

FIG. 3 is a schematic top view of a metalens unit according to an embodiment of the disclosure.

FIG. 4 is a three-dimensional schematic view of one microstructure of the metalens unit according to an embodiment of the disclosure.

FIG. 5 illustrates phase distribution corresponding to changes of a second dimension and a first dimension of the microstructure by inputting incident light whose polarization direction is parallel to a second direction under a wavelength of red light.

FIG. 6 illustrates the phase distribution corresponding to the changes of the second dimension and the first dimension of the microstructure by inputting incident light whose polarization direction is parallel to a first direction under the wavelength of red light.

FIG. 7 illustrates the phase distribution corresponding to changes of the second dimension and the first dimension of the microstructure by inputting incident light whose polarization direction is parallel to the second direction under a wavelength of green light.

FIG. 8 illustrates the phase distribution corresponding to changes of the second dimension and the first dimension of the microstructure by inputting incident light whose polarization direction is parallel to the first direction under the wavelength of green light.

FIG. 9 illustrates the phase distribution corresponding to changes of the second dimension and the first dimension of the microstructure by inputting incident light whose polarization direction is parallel to the second direction under a wavelength of blue light.

FIG. 10 illustrates the phase distribution corresponding to changes of the second dimension and the first dimension of the microstructure by inputting incident light whose polarization direction is parallel to the first direction under the wavelength of blue light.

FIG. 11 illustrates a phase profile required to deflect the incident light by 10°.

FIG. 12 illustrates the phase profile required to deflect the incident light by 30°.

FIG. 13 illustrates a far field plot of a light beam whose polarization direction is parallel to the first direction.

FIG. 14 illustrates a far field plot of a light beam whose polarization direction is parallel to the second direction.

FIG. 15 illustrates a plot of wave propagation of the light beam whose polarization direction is parallel to the first direction.

FIG. 16 illustrates a plot of wave propagation of the light beam whose polarization direction is parallel to the second direction.

FIG. 17 is a schematic top view of a first metalens unit according to an embodiment of the disclosure.

FIG. 18 is a schematic top view of a second metalens unit according to an embodiment of the disclosure.

FIG. 19 is a schematic top view of a third metalens unit according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

It should be understood that when an element such as a layer, film, region or substrate is referred to as being “on” or “connected to” another element, it means that the element is directly on or connected to the another element, or an intervening element may be provided therebetween. In contrast, when an element is referred to as being “directly on” or “directly connected to” another element, there are no intervening elements present. As used herein, the term “connected” may refer to physical connection and/or electrical connection. Further, the “electrical connection” or “coupling” may be that other elements are provided between two elements.

The terms used herein such as “about”, “approximate”, or “substantial” include a related value and an average within an acceptable deviation range of specific values determined by those with ordinary skills in the art with consideration of discussed measurement and a specific number of errors related to the measurement (i.e., a limitation of a measurement system). For example, “about” may mean within one or more standard deviations, or within, for example, ±30%, ±20%, ±15%, ±10%, and ±5% of the stated value. Moreover, a relatively acceptable range of deviation or standard deviation may be chosen for the term “about”, “approximately”, or “substantially” as used herein based on optical properties, etching properties or other properties, instead of applying one standard deviation across all the properties.

Unless otherwise defined, all terms (including technical and scientific terms) used herein have the same meaning as commonly understood by a person having ordinary skill in the art. It will be further understood that, terms such as those defined in commonly used dictionaries should be interpreted as having a meaning that is consistent with their meaning in the context of the related art, and these terms are not to be construed in an idealized or excessively formal sense unless explicitly defined as such herein.

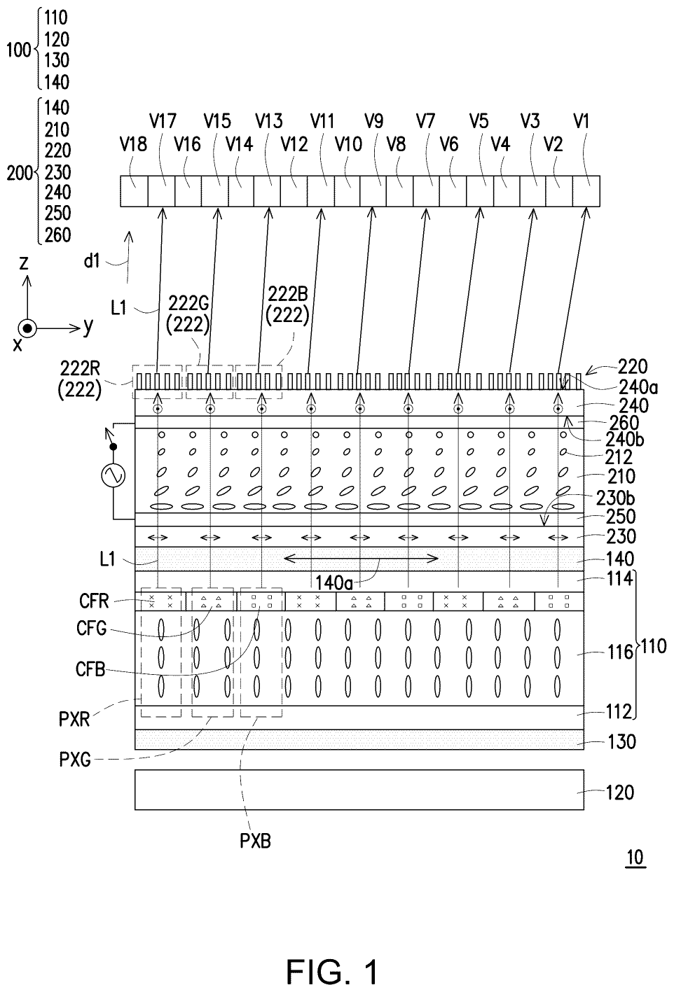

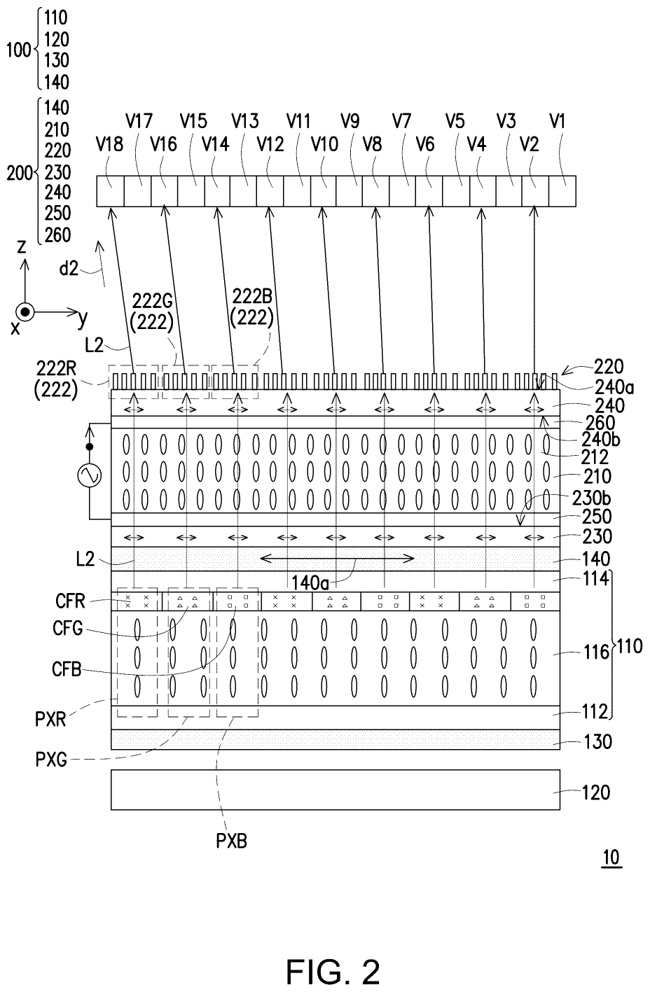

FIG. 1 is a cross-sectional schematic view of the light field display apparatus according to an embodiment of the disclosure. FIG. 2 is a cross-sectional schematic view of the light field display apparatus according to an embodiment of the disclosure. In particular, FIG. 1 illustrates a light path when a switching element 200 is not enabled, and FIG. 2 illustrates a light path when the switching element 200 is enabled.

With reference to FIG. 1 and FIG. 2, a light field display apparatus 10 includes a display element 100. The display element 100 has a plurality of pixels PXR, PXG, and PXB. To be specific, in this embodiment, the display element 100 includes a display panel 110. The display panel 110 includes a pixel array substrate 112, an opposite substrate 114, and a display medium 116 disposed between the pixel array substrate 112 and the opposite substrate 114. The pixel array substrate 112 has a plurality of pixel driving circuits (not shown) and a plurality of pixel electrodes (not shown) electrically connected to the plurality of pixel driving circuits. Each pixel PXR/PXG/PXB may include one pixel driving circuit, one pixel electrode electrically connected to the pixel driving circuit, and a portion of the display medium 116 overlapping the pixel electrode.

In an embodiment, each pixel PXR/PXG/PXB may optionally include a color filter pattern CFR/CFG/CFB overlapping the pixel electrode (not shown). For instance, in an embodiment, the plurality of pixels PXR, PXG, and PXB include a first pixel PXR, a second pixel PXG, and a third pixel PXB for respectively displaying a first color, a second color, and a third color. The plurality of color filter patterns CFR, CFG, and CFB include a first color filter pattern CFR, a second color filter pattern CFG, and a third color filter pattern CFB respectively having the first color, the second color, and the third color. The first pixel PXR, the second pixel PXG, and the third pixel PXB respectively include the first color filter pattern CFR, the second color filter pattern CFG, and the third color filter pattern CFB, so as to respectively display the first color, the second color, and the third color. For instance, in an embodiment, the first color, the second color, and the third color may be red, green, and blue, respectively. The first color filter pattern CFR, the second color filter pattern CFG, and the third color filter pattern CFB can be a red filter pattern, a green filter pattern, and a blue filter patterns respectively, but the disclosure is not limited thereto.

In an embodiment, the display medium 116 may optionally be a non-self-luminous display medium (such as but not limited to: a liquid crystal layer), and the display element 100 may further include a backlight source 120 and a plurality of polarizers 130 and 140. The backlight source 120 is disposed under the display panel 110, the plurality of polarizers 130 and 140 are disposed on upper and lower sides of the display panel 110, and one polarizer 130 is located between the display panel 110 and the backlight source 120. In an embodiment, the backlight source 120 preferably has characteristics such as high directivity and single polarization. In an embodiment, the display panel 110 is an example of a non-self-luminous display panel. However, the disclosure is not limited thereto, and in other embodiments, the display panel 110 may also be a self-luminous display panel (e.g., an organic light-emitting diode display panel, a micro light-emitting diode display panel, etc.), and the display element 100 does not necessarily include the backlight source 120 and/or the polarizers 130 and 140.

The light field display apparatus 10 further includes the switching element 200 disposed on the display element 100. The switching element 200 includes the polarizer 140, a liquid crystal layer 210, and a metalens array 220. The polarizer 140, the liquid crystal layer 210, and the metalens array 220 are sequentially disposed on the pixels PXR, PXG, and PXB of the display element 100. To be specific, the polarizer 140, the liquid crystal layer 210, and the metalens array 220 are sequentially stacked on the pixels PXR, PXG, and PXB of the display element 100 in a third direction z away from the display medium 116 of the display element 100. In an embodiment, the switching element 200 and the display element 100 may optionally share the same polarizer 140, but the disclosure is not limited thereto.

The switching element 200 is used for switching a polarization direction of incident light. In other words, whether the switching element 200 is enabled or not determines whether the polarization direction of the incident light passing through the liquid crystal layer 210 changes. For instance, in an embodiment, as shown in FIG. 1, the switching element 200 is not enabled (i.e., when a plurality of liquid crystal molecules 212 of the liquid crystal layer 210 are not subjected to a sufficiently large electric field to rotate), the polarization direction of the incident light passing through the liquid crystal layer 210 of the switching element 200 may be changed. As shown in FIG. 2, the switching element 200 is enabled (i.e., when the plurality of liquid crystal molecules 212 of the liquid crystal layer 210 are subjected to a sufficiently large electric field to rotate), the polarization direction of the incident light passing through the liquid crystal layer 210 may remain unchanged.

To be specific, in an embodiment, the switching element 200 further includes a first light-transmitting substrate 230 close to the polarizer 140, a second light-transmitting substrate 240 away from the polarizer 140, a first electrode 250, and a second electrode 260. The liquid crystal layer 210 is disposed between the first light-transmitting substrate 230 and the second light-transmitting substrate 240. The metalens array 220 may be disposed on an outer surface 240a or an inner surface 240b of the second light-transmitting substrate 240. A potential difference between the first electrode 250 and the second electrode 260 is used to form an electric field to drive the plurality of liquid crystal molecules 212 of the liquid crystal layer 210. In an embodiment, the first electrode 250 and the second electrode 260 may be optionally disposed on an inner surface 230b of the first light-transmitting substrate 230 and the inner surface 240b of the second light-transmitting substrate 240 respectively. The first electrode 250 may completely cover the inner surface 230b of the first light-transmitting substrate 230, and the second electrode 260 may completely cover the inner surface 240b of the second light-transmitting substrate 240, but the disclosure is not limited thereto.

When being enabled and being not enabled, the liquid crystal layer 210 of the switching element 200 has different effects on changing the polarization direction of the incident light. The metalens array 220 has different deflection effects on incident light with different polarization directions. Through the combination of the liquid crystal layer 210 of the switching element 200 and the metalens array 220, incident light with different polarization directions may be deflected in different directions and transmitted to different viewing zones. Further, when the liquid crystal layer 210 of the switching element 200 switches the polarization direction of the incident light by time division, the image information of the plurality of pixels PXR, PXG, and PXB is switched synchronously, so that the image information of the corresponding viewing zone is displayed. In this way, the number of pixels required for a voxel can be greatly reduced, and the resolution of a single view can be doubled. The following examples are provided for illustration together with FIG. 1 and FIG. 2.

With reference to FIG. 1, in a first time interval, the plurality of pixels PXR, PXG, and PXB of the display element 100 provide a first light beam L1, the first light beam L1 has first image information corresponding to a first group of viewing zones, and the switching element 200 is not enabled. Herein, the first light beam L1 from the plurality of pixels PXR, PXG, and PXB has a first polarization direction after passing through the polarizer 140 and the liquid crystal layer 210 in sequence. The first light beam L1 having the first polarization direction enters the metalens array 220 at an incident angle (such as but not limited to: 0°). The first light beam L1 entering the metalens array 220 is deflected after passing through the metalens array 220, transmitted in a first transmission direction d1, and then guided to the first group of viewing zones.

With reference to FIG. 2, in a second time interval following the first time interval, the plurality of pixels PXR, PXG, and PXB of the display element 100 provide a second light beam L2, the second light beam L2 has second image information corresponding to a second group of viewing zones, and the switching element 200 is enabled. Herein, the second light beam L2 from the plurality of pixels PXR, PXG, and PXB has a second polarization direction after passing through the polarizer 140 and the liquid crystal layer 210 in sequence. The second light beam L2 having the second polarization direction enters the metalens array 220 at an incident angle (such as but not limited to: 0°). The second light beam L2 entering the metalens array 220 is deflected after passing through the metalens array 220, transmitted in a second transmission direction d2, and then guided to the second group of viewing zones.

With reference to FIG. 1 and FIG. 2, in the different first time interval and the second time interval, the first light beam L1 and the second light beam L2 transmitted to the different first group of viewing zones and the second groups of viewing zones respectively carry the first image information and the second image information corresponding to different viewing zones. After the human eyes receive the first image information and the second image information, a three-dimensional image can be formed in the brain. It should be noted that the first light beam L1 and the second light beam L2 carrying the first image information and the second image information corresponding to different viewing zones come from the same group of pixels PXR, PXG, and PXB, rather than from different groups of pixels PXR, PXG, and PXB. In this way, the number of pixels required to form a voxel is reduced, and the resolution of a single view can be doubled.

With reference to FIG. 1 and FIG. 2, the polarizer 140 has a transmission axis 140a, and a first direction y is parallel to the transmission axis 140a. A second direction x is perpendicular to the first direction y and parallel to the display element 100. A 1^{st} to N^{th} viewing zones are sequentially arranged, N is a positive integer greater than or equal to 2, and the 1^{st} to N^{th} viewing zones include odd-numbered viewing zones and even-numbered viewing zones. In an embodiment, N may optionally be 18, and the 1^{st} to 18^{th} viewing zones V1 to V18 are arranged in sequence. The 1^{st} to 18^{th} viewing zones include odd-numbered viewing zones V1, V3, V5, V7, V9, V11, V13, V15, and V17 and even-numbered viewing zones V2, V4, V6, V8, V10, V12, V14, V16, and V18.

With reference to FIG. 1, for instance, in an embodiment, in the first time interval, the plurality of pixels PXR, PXG, and PXB of the display element 100 provide the first light beam L1, the first light beam L1 has the first image information corresponding to the odd-numbered viewing zones V1, V3, V5, V7, V9, V11, V13, V15, and V17, and the switching element 200 is not enabled. Herein, the polarization direction of the first light beam L1 from the plurality of pixels PXR, PXG, and PXB is parallel to the first direction y after the first light beam L1 passes through the polarizer 140. The polarization direction of the first light beam L1 parallel to the first direction y is changed to be parallel to the second direction x after the first light beam L1 passes through the liquid crystal layer 210 of the switching element 200 that is not enabled. The first light beam L1 whose polarization direction is parallel to the second direction x passes through the metalens array 220, is transmitted in the first transmission direction d1, and then further guided to the odd-numbered viewing zones V1, V3, V5, V7, V9, V11, V13, V15, and V17.

With reference to FIG. 2, for instance, in an embodiment, in the second time interval, the plurality of pixels PXR, PXG, and PXB of the display element 100 provide the second light beam L2, the second light beam L2 has the second image information corresponding to the even-numbered viewing zones V2, V4, V6, V8, V10, V12, V14, V16, and V18, and the switching element 200 is enabled. Herein, the polarization direction of the second light beam L2 from the plurality of pixels PXR, PXG, and PXB is parallel to the first direction y after the second light beam L2 passes through the polarizer 140. The polarization direction of the second light beam L2 parallel to the first direction y remains unchanged and is still parallel to the first direction y after the second light beam L2 passes through the liquid crystal layer 210 of the enabled switching element 200. The second light beam L2 whose polarization direction is parallel to the first direction y passes through the metalens array 220, is transmitted in the second transmission direction d2, and then further guided to the even-numbered viewing zones V2, V4, V6, V8, V10, V12, V14, V16, and V18.

With reference to FIG. 1 and FIG. 2, in the different first time interval and the second time interval, the first light beam L1 and the second light beam L2 transmitted to the odd-numbered viewing zones V1, V3, V5, V7, V9, V11, V13, V15, and V17 and the even-numbered viewing zones V2, V4, V6, V8, V10, V12, V14, V16, and V18 respectively carry the first image information and the second image information corresponding to the odd-numbered viewing zones V1, V3, V5, V7, V9, V11, V13, V15, and V17 and the even-numbered viewing zones V2, V4, V6, V8, V10, V12, V14, V16, and V18. After the human eyes receive the first image information and the second image information, a three-dimensional image can be formed in the brain. It should be noted that the first light beam L1 and the second light beam L2 carrying the first image information and the second image information corresponding to the odd-numbered viewing zones V1, V3, V5, V7, V9, V11, V13, V15, and V17 and the even-numbered viewing zones V2, V4, V6, V8, V10, V12, V14, V16, and V18 come from the same group of 9 pixels PXR, PXG, and PXB, rather than from 18 pixels PXR, PXG, PXB divided into two groups. In this way, the number of pixels required to form a voxel can be halved, and the resolution of a single view can be doubled.

In the embodiments shown in FIG. 1 and FIG. 2, the plurality of pixels PXR, PXG, and PXB required to form a voxel can be optionally arranged in a row in the first direction y. That is, in the embodiments shown in FIG. 1 and FIG. 2, the 9 pixels PXR, PXG, and PXB arranged in a row in the first direction y can form a pixel group required by a voxel. However, the disclosure is not limited thereto, and in other embodiments, one pixel group required to form a voxel may also be arranged in other ways. For instance, in another embodiment that is not shown, the plurality of pixels PXR, PXG, and PXB required to form a voxel may also be arranged in a 3×3 matrix in the first direction y and in the second direction x.

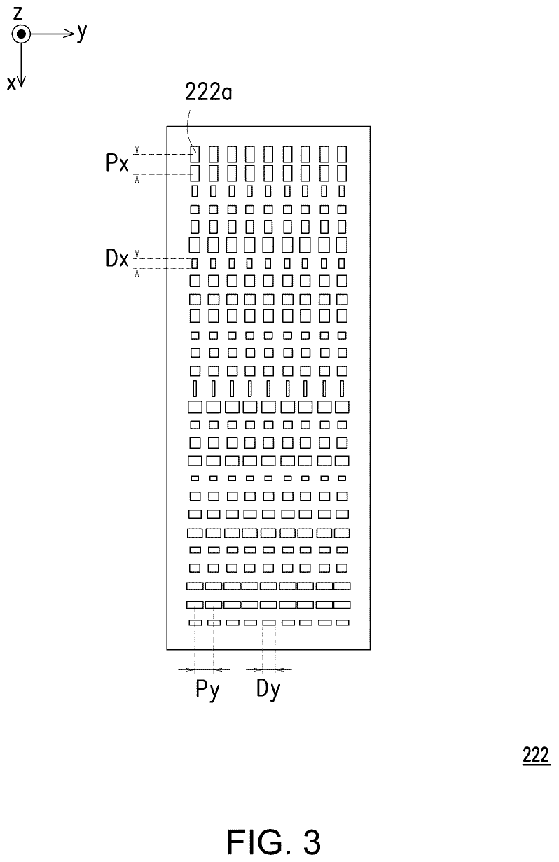

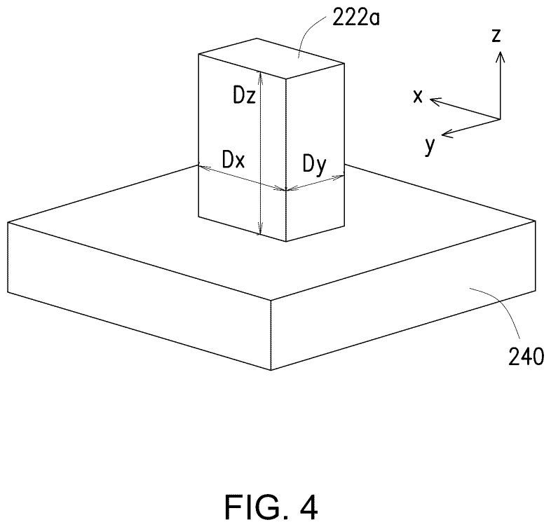

FIG. 3 is a schematic top view of a metalens unit according to an embodiment of the disclosure. FIG. 4 is a three-dimensional schematic view of one microstructure of the metalens unit according to an embodiment of the disclosure.

With reference to FIG. 1 and FIG. 3, the metalens array 200 has a plurality of metalens units 222 overlapping the plurality of pixels PXR, PXG, and PXB. With reference to FIG. 3 and FIG. 4, each metalens unit 222 includes a plurality of microstructures 222a arranged in an array. The third direction z is perpendicular to the first direction y and the second direction x. Each microstructure 222a has a first dimension Dy, a second dimension Dx, and a third dimension Dz respectively in the first direction y, the second direction x, and the third direction z. Adjacent two of the microstructures 222a of each metalens unit 222 have a first distance Py in the first direction y, one microstructure 222a of each metalens unit 222 has the first dimension Dy in the first direction y, and a ratio (Dy/Py) of the first dimension Dy to the first distance Py is called a Y filling ratio. Adjacent two of the microstructures 222a of each metalens unit 222 have a second distance Px in the second direction x, one microstructure 222a of each metalens unit 222 has the second dimension Dx in the second direction x, and a ratio (Dx/Px) of the second dimension Dx to the second distance Px is called an X filling ratio.

In an embodiment, the plurality of third dimensions Dz (i.e., heights) of the plurality of microstructures 222a of each metalens unit 222 may be substantially the same, the plurality of first dimensions Dy of at least part of the plurality of microstructures 222a of each metalens unit 222 may be different, and the plurality of second dimensions Dx of at least part of the plurality of microstructures 222a of each metalens unit 222 may be different. In an embodiment, the ratio (Dy/Py) of the first dimension Dy of one microstructure 222a of each metalens unit 222 to the first distance Py, i.e., the Y filling ratio, may fall within a range of 0.1 to 0.9. In an embodiment, the ratio (Dx/Px) of the second dimension Dx of one microstructure 222a of each metalens unit 222 to the second distance Px, i.e., the X filling ratio, may fall within a range of 0.1 to 0.9.

Two incident lights whose polarization directions are parallel to the first direction y and the second direction x may produce different responses to the same metalens unit 222. The microstructures 222a may be treated as truncated waveguides. By adjusting the ratio of the first dimension Dy to the second dimension Dx, different equivalent refractive indices may be generated to provide two independent phase distributions of two kinds of incident light whose polarization directions are parallel to the first direction y and the second direction x.

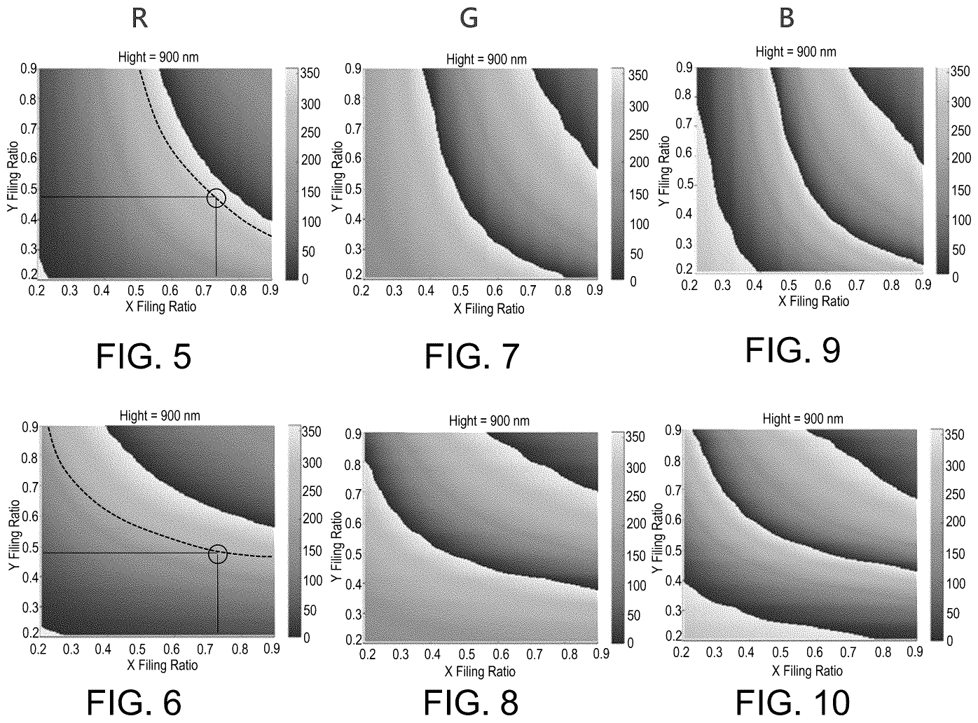

FIG. 5 illustrates the phase distribution corresponding to changes of the second dimension Dx and the first dimension Dy of the microstructure 222a by inputting incident light whose polarization direction is parallel to the second direction x under a wavelength of red light, where the third dimension Dz of the microstructure 222a is 900 nm. FIG. 6 illustrates the phase distribution corresponding to changes of the second dimension Dx and the first dimension Dy of the microstructure 222a by inputting incident light whose polarization direction is parallel to the first direction y under the wavelength of red light, where the third dimension Dz of the microstructure 222a is 900 nm.

FIG. 7 illustrates the phase distribution corresponding to changes of the second dimension Dx and the first dimension Dy of the microstructure 222a by inputting incident light whose polarization direction is parallel to the second direction x under a wavelength of green light, where the third dimension Dz of the microstructure 222a is 900 nm. FIG. 8 illustrates the phase distribution corresponding to changes of the second dimension Dx and the first dimension Dy of the microstructure 222a by inputting incident light whose polarization direction is parallel to the first direction y under the wavelength of green light, where the third dimension Dz of the microstructure 222a is 900 nm.

FIG. 9 illustrates the phase distribution corresponding to changes of the second dimension Dx and the first dimension Dy of the microstructure 222a by inputting incident light whose polarization direction is parallel to the second direction x under a wavelength of blue light, where the third dimension Dz of the microstructure 222a is 900 nm. FIG. 10 illustrates the phase distribution corresponding to changes of the second dimension Dx and the first dimension Dy of the microstructure 222a by inputting incident light whose polarization direction is parallel to the first direction y under the wavelength of blue light, where the third dimension Dz of the microstructure 222a is 900 nm.

According to the metalens unit 222, when two kinds of light whose polarization directions are parallel to the first direction y and the second direction x are incident, according to a set deflection angle, the phase distribution of the light wave deflection corresponding to a surface where the metalens unit 222 is located is calculated first. Next, from the phase distribution obtained by scanning various parameters of the first dimension Dy and the second dimension Dx of the microstructure 222a, the first dimension Dy and the second dimension Dx of the microstructure 222a to be fabricated at each position of the metalens unit 222 are found. For instance, assuming that two kinds of red light whose polarization directions are parallel to the second direction x and the first direction y are incident, the metalens unit 222 needs to provide phase shifts of 300° and 200° respectively, as shown in FIG. 5 and FIG. 6 respectively. The two dotted lines respectively marked in FIG. 5 and FIG. 6 correspond to the required phase shifts (i.e., 300° and 200°) of the two kinds of red light whose polarization directions are respectively parallel to the second direction x and the first direction y. An intersection point P1 of the two dotted lines in FIG. 5 and FIG. 6 is the target point, and the X filling ratio and the Y filling ratio corresponding to the intersection point Pl are used as the structural parameters of the microstructure 222a at this position.

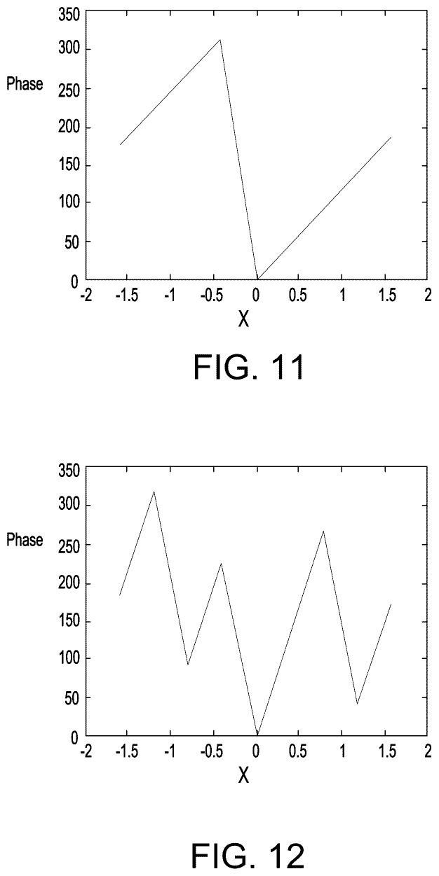

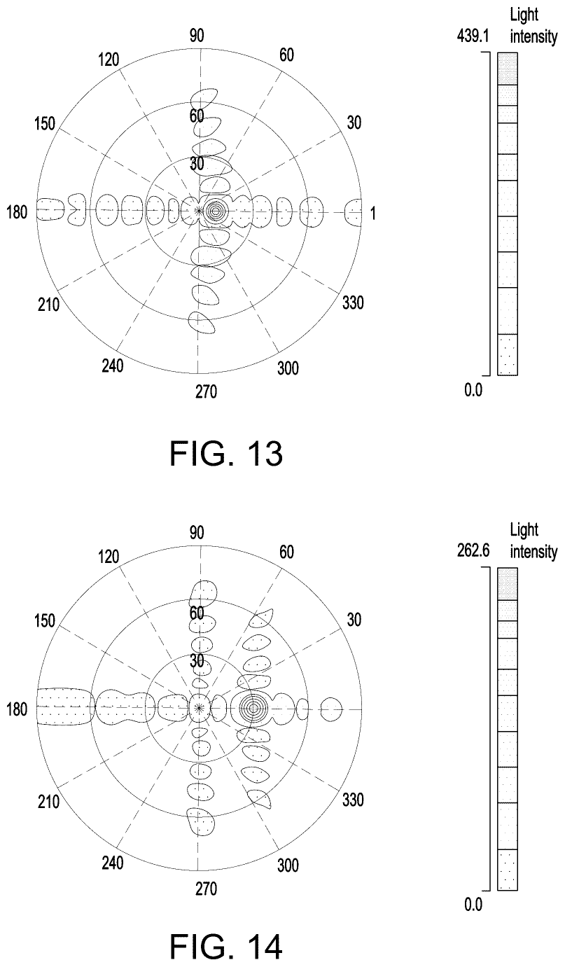

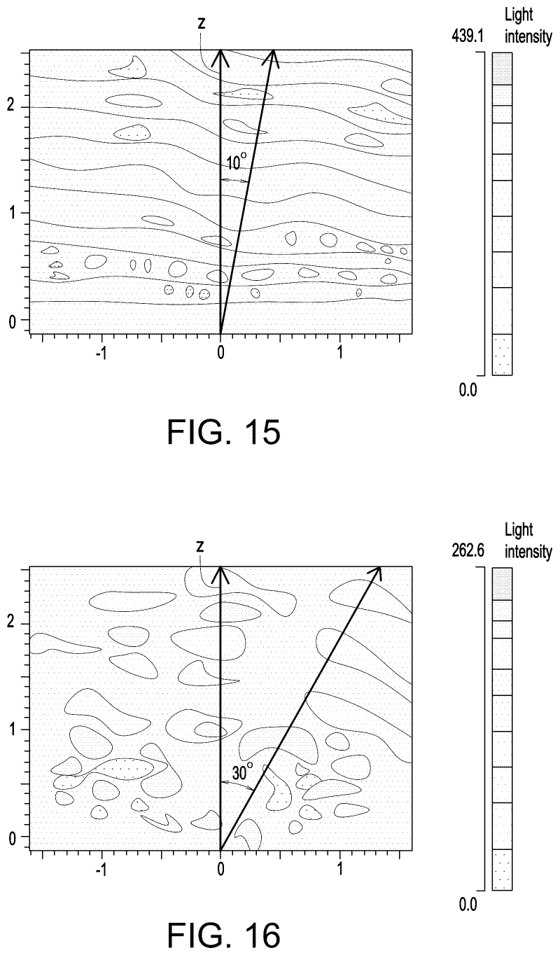

FIG. 11 illustrates a phase profile required to deflect the incident light by 10°. FIG. 12 illustrates the phase profile required to deflect the incident light by 30°. FIG. 13 illustrates a far field plot (far field intensity) of a light beam whose polarization direction is parallel to the first direction y. FIG. 14 illustrates a far field plot (far field intensity) of a light beam whose polarization direction is parallel to the second direction x. FIG. 15 illustrates a plot of wave propagation of the light beam whose polarization direction is parallel to the first direction y. FIG. 16 illustrates a plot of wave propagation of the light beam whose polarization direction is parallel to the second direction x.

For instance, when the wavelength includes green light at 532 nm, the period of the structural parameters of the microstructure 222a is 350 nm, the third dimension Dz of the microstructure 222a is 600 nm, the deflection angle of the incident light whose polarization direction is parallel to the first direction y is 10° and deflection angle of the incident light whose polarization direction is parallel to the second direction x is 30°, the required phase profile may be calculated from the deflection of 10° and 30° first. Next, the X filling ratio and the Y filling ratio required by the corresponding microstructure 222a are found from the phase distributions shown in FIG. 7 and FIG. 8. Because the two kinds of incident light with the same incident angle but different polarization directions exit at different exit angles after passing through the metalens unit 222, and the corresponding first dimension Dy and second dimension Dx of the microstructure change periodically. The simulation results may be analyzed from the far field plots (far field intensity) in FIG. 13 and FIG. 14 and the plots of wave propagation in FIG. 15 and FIG. 16. From the far field plots of FIG. 13 and FIG. 14, it can be seen that the light beam that is incident on the metalens unit 222 and whose polarization direction is parallel to the first direction y may be deflected by the metalens unit 222 and exit at an exit angle of 10°, and the light beam that is incident on the metalens unit 222 and whose polarization direction is parallel to the second direction x may be deflected by the metalens unit 222 and exit at an exit angle of 30°. From plots of wave propagation of FIG. 15 and FIG. 16, the same result as above may be obtained. That is, when two kinds of different polarized light are inputted, the included angles between the transmission direction and the forward direction (i.e., the third direction z) of the exiting light may be 10° and 30° respectively.

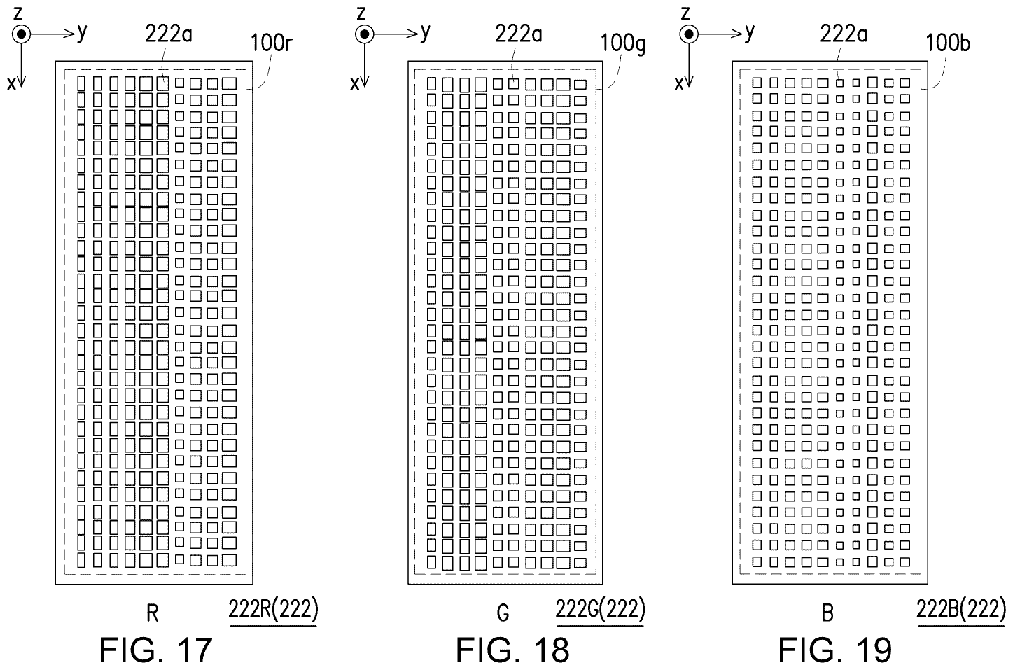

FIG. 17 is a schematic top view of a first metalens unit according to an embodiment of the disclosure. FIG. 18 is a schematic top view of a second metalens unit according to an embodiment of the disclosure. FIG. 19 is a schematic top view of a third metalens unit according to an embodiment of the disclosure.

With reference to FIG. 1, FIG. 17, FIG. 18, and FIG. 19, in an embodiment, the plurality of pixels PXR, PXG, and PXB include the first pixel PXR, the second pixel PXG, and the third pixel PXB for respectively displaying the first color, the second color, and the third color. The plurality of metalens units 222 include a first metalens unit 222R, a second metalens unit 222G, and a third metalens unit 222B respectively overlapping the first pixel PXR, the second pixel PXG, and the third pixel PXB. Further, a structure of the first metalens unit 222R, a structure of the second metalens unit 222G, and a structure of the third metalens unit 222B are different from one another.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A light field display apparatus, comprising:
a display element having a plurality of pixels; and
a switching element disposed on the display element, wherein the switching element comprises:
a polarizer;
a liquid crystal layer; and
a metalens array, wherein the metalens array has a plurality of metalens units overlapping the plurality of pixels, and the polarizer, the liquid crystal layer, and the metalens array are sequentially disposed on the plurality of pixels of the display element.

2. The light field display apparatus according to claim 1, wherein a first light beam passing through the polarizer and the liquid crystal layer has a first polarization direction when the switching element is not enabled, the first light beam having the first polarization direction and entering the metalens array at an incident angle is transmitted in a first transmission direction after passing through the metalens array, a second light beam passing through the polarizer and the liquid crystal layer has a second polarization direction when the switching element is enabled, the second polarization direction is substantially perpendicular to the first polarization direction, the second light beam having the second polarization direction and entering the metalens array at the incident angle is transmitted in a second transmission direction after passing through the metalens array, and the first transmission direction is different from the second transmission direction.

3. The light field display apparatus according to claim 1, wherein a 1^{st} to N^{th} viewing zones are sequentially arranged, N is a positive integer greater than or equal to 2, the 1^{st} to N^{th} viewing zones include odd-numbered viewing zones and even-numbered viewing zones, the plurality of pixels from the display element and a first light beam passing through the polarizer, the liquid crystal layer, and the metalens array are guided to one of the odd-numbered viewing zones and the even-numbered viewing zones when the switching element is not enabled, and the plurality of pixels from the display element and a second light beam passing through the polarizer, the liquid crystal layer, and the metalens array are guided to the other one of the odd-numbered viewing zones and the even-numbered viewing zones when the switching element is enabled.

4. The light field display apparatus according to claim 1, wherein the polarizer has a transmission axis, a first direction is parallel to the transmission axis, a second direction is perpendicular to the first direction and parallel to the display element, a third direction is perpendicular to the first direction and the second direction, each metalens unit comprises a plurality of microstructures arranged in an array, each microstructure has a first dimension, a second dimension, and a third dimension respectively in the first direction, the second direction, and the third direction, the plurality of third dimensions of the microstructures are substantially the same, the plurality of first dimensions of at least part of the microstructures are different, and the plurality of second dimensions of at least part of the microstructures are different.

5. The light field display apparatus according to claim 1, wherein the polarizer has a transmission axis, a first direction is parallel to the transmission axis, each metalens unit comprises a plurality of microstructures, adjacent two of the microstructures have a first distance in the first direction, one of the microstructures has a first dimension in the first direction, and a ratio of the first dimension to the first distance falls within a range of 0.1 to 0.9.

6. The light field display apparatus according to claim 5, wherein a second direction is perpendicular to the first direction and parallel to the display element, adjacent two of the microstructures have a second distance in the second direction, one of the microstructures has a second dimension in the second direction, and a ratio of the second dimension to the second distance falls within a range of 0.1 to 0.9.

7. The light field display apparatus according to claim 1, wherein the plurality of pixels comprise a first pixel and a second pixel for respectively displaying a first color and a second color, the plurality of metalens units comprise a first metalens unit and a second metalens unit respectively overlapping the first pixel and the second pixel, and a structure of the first metalens unit is different from a structure of the second metalens unit.

8. The light field display apparatus according to claim 7, wherein the plurality of pixels further comprise a third pixel for displaying a third color, the plurality of metalens units further comprise a third metalens unit overlapping the third pixel, and the structure of the first metalens unit, the structure of the second metalens unit, and a structure of the third metalens unit are different from one another.
